(19) United States
(12) Patent Application Publication
(10) Pub. No.: US 2004/0017293 A1
(43) Pub. Date: Jan. 29, 2004

(54) Talking locator device and system

(76) Inventor: Timothy Webster, Mableton, GA (US)

Correspondence Address: Sutherland Asbill & Brennan, LLP, 999 Peachtree St. N.E., Atlanta, GA, 30309, US

(21) Appl. No.: 10/201,583

(22) Filed: Jul. 23, 2002

(51) Int. Cl. G08B 1/08

(52) U.S. Cl. 340/539.32

(57) ABSTRACT

A talking locator device and system for locating an object. The talking locator device comprises recording means for recording at least one audible message, receiver means for receiving control signals wirelessly transmitted by a remotely located transmitter, and control means responsive to a first type of control signal for initiating playback of at least one of the audible messages and responsive to a second type of control signal for initiating recording of at least one of the audible messages. The audible message may be made in a user's voice. The talking locator device may be attached to an object and when the audible message is played in response to a control signal received from the transmitter, the user is provided with an indication of the location of the object.

### TECHNICAL FIELD

The present invention relates generally to electronic devices used for locating lost or misplaced objects, such as remote control units, keys and other items. More particularly, the present invention relates to a transmitter and receiver system for recording and playing an audible message that can be used to determine the location of an object.

### BACKGROUND OF THE INVENTION

Small personal and household object are easily and often lost or misplaced. As an example, remote control units for audio and video equipment can be lost in the cushions of a sofa, or under the sheets or blankets of a bed. Similarly, keys, mobile phones, pagers and other objects can be dropped or placed in locations where they are not typically stored. Searching for lost or misplaced objects can be frustrating and time consuming.

Several systems have been proposed for assisting in the location of lost or misplaced objects. For example, systems are known in which a radio signal is used to activate an alarm device that had been placed on an object prior to its being lost or misplaced. U.S. Pat. No. 4,101,873, in particular, shows a device for locating missing articles, such as eyeglasses or purses. A small transmitter is worn by the user and a small receiver is attached to the object to be located. When the transmitter is activated, its signal is detected by the receiver, which actuates the alarm, giving the user an indication of the location of the object. Other patents which describe systems for sounding an alarm to locate missing articles include U.S. Pat. Nos. 4,476,469, 4,507,653, 4,591,835 and 4,598,272. All of the above-cited patents are hereby incorporated by reference as if set forth fully herein.

None of the prior art systems disclose or suggest a locator device that plays user-recorded audible messages to assist in locating an object.

### SUMMARY OF THE INVENTION

The present invention provides a talking locator device and system for locating an object. The system comprises a locator attached to an object to be located and a transmitter located remote from the locator for wirelessly transmitting control signals in response to activation by a user. The locator includes means for storing at least one recorded voice message and playback means for playing at least one of the recorded voice messages, which may be selected randomly, in response to a control signal being received by the locator. At least one of the recorded voice messages stored by the locator may be a pre-recorded message. The locator may also include recording means for recording at least one of the recorded voice messages. The recording means may be responsive to a second control signal transmitted by the transmitter and received by the locator. Thus, at least one of the recorded voice messages may be a recording of the user's voice.

Within the system, the transmitter and the locator may be similarly colored so as to indicate a correspondence between the transmitter and the locator. The first control signal may be transmitted by the transmitter at a first frequency and the second control signal may be transmitted by the transmitter at a second frequency. The locator may include a receiver tuned to the first frequency and the second frequency. The volume level for playback of the recorded voice messages may be proportional to the strength of the control signals received from the transmitter. The locator may also include a port for receiving and storing at least one audio file from an external device. A control signal from the transmitter may initiate playback of at least one of the stored audio files.

In other embodiments, the present invention provides a talking locator device for locating an object. The talking locator device comprises recording means for recording at least one audible message, receiver means for receiving control signals wirelessly transmitted by a remotely located transmitter, control means responsive to a first type of control signal for initiating playback of at least one of the audible messages and responsive to a second type of control signal for initiating recording of at least one of the audible messages, and means for attaching the talking locator device to an object to be located. The audible message may be made in a user's voice. The transmitter may be operable to transmit the first type of control signal in response to a user operating a control mechanism in a first manner and to transmit the second type of control signal in response to the user operating the control mechanism in a second manner. Alternatively, the transmitter may be operable to transmit the first type of control signal in response to a user operating a first control mechanism and to transmit the second type of control signal in response to the user operating a second control mechanism. The first type of control signal may be transmitted at a first frequency and the second type of control signal may be transmitted at a second frequency. The receiver means of the locator may be tuned to the first frequency and the second frequency.

The talking locator device may be adapted such that the volume level for playback of the audible message is proportional to the strength of the control signals received from the transmitter. The talking locator device may also include means for receiving and storing at least one audio file from an external device. The control means may be responsive to a control signal for initiating playback of at least one of the stored audio files.

### BRIEF DESCRIPTION OF THE DRAWINGS

FIG. 1 is a diagram showing a basic arrangement of a talking locator device system according to exemplary embodiments of the present invention.

FIG. 2 is a block diagram showing the major components of a transmitter in accordance with exemplary embodiments of the present invention

FIG. 3 is a block diagram of the major components of a locator in accordance with exemplary embodiments of the present invention.

### DETAILED DESCRIPTION OF THE INVENTION

The present invention provides a “talking” locator device and system. The talking locator device is attached to an object that is prone to being lost or misplaced. For example, the talking locator device may be attached to a remote control unit, a set of keys, a purse, a wallet, a pager or other personal and/or household objects. The talking locator device is configured to sound audible voice messages in response to receiving a signal from a transmitter. The audible voice messages may be pre-recorded messages or messages recorded by the user in the user's own voice or otherwise. By way of illustration, the audible voice messages may be phrases, such as “I'm over here, Dummy!” or “Here I am!” Thus, the talking locator device can be used to add a bit of humor to the sometimes frustrating task of searching for lost or misplaced objects.

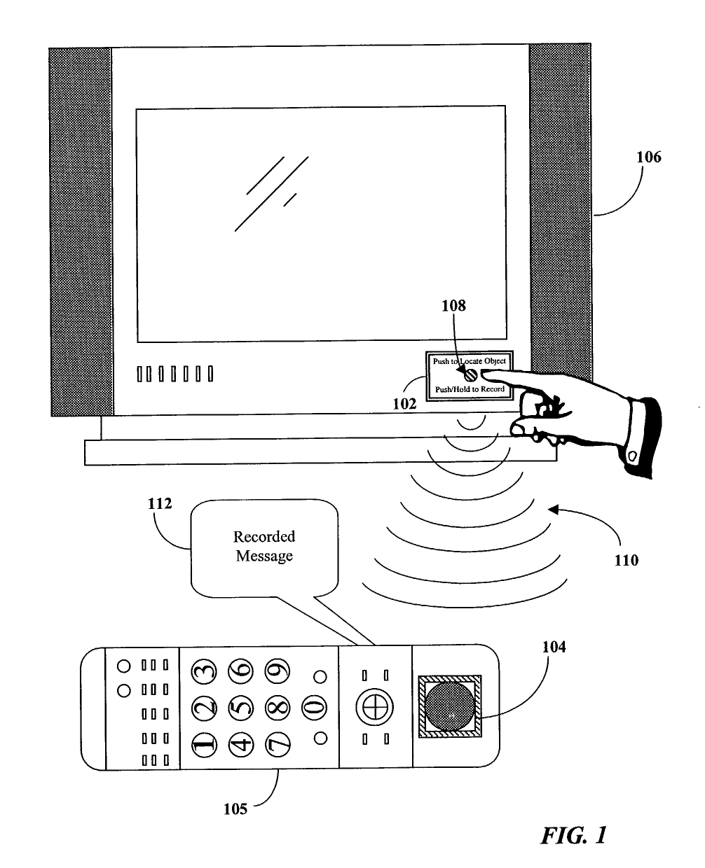

Exemplary embodiments of the present invention will hereinafter be described with reference to the figures, in which like numerals indicate like elements throughout the several drawings. FIG. 1 shows a basic arrangement of a system according to certain embodiments of the present invention. As shown, the system includes a transmitter 102 and a locator 104. The transmitter 102 is preferably mounted or otherwise connected to a stationary object, such as a television 106, so that it is assured not to be lost or misplaced. The locator 104 is intended to be attached or otherwise connected to a portable and often lost or misplaced object, such as a remote control unit 105. The transmitter 102 and the locator 104 may be attached to the respective objects by way of adhesive, Velcro, magnet, mechanical fastener, or any other suitable product or process known in the art.

The transmitter includes a button 108 or other control mechanism for allowing a user to activate the transmitter 102. When activated, the transmitter emits a control signal 110 that can be received by the locator 104. The control signal 110 may be emitted using any appropriate signaling technology, such as RF, UHF, ultrasound, infrared, microwave and the like. Preferably, however, the signaling technology employed should not require a direct line of sight between the transmitter 102 and the locator 104.

In response to detecting the control signal 110 emitted by the transmitter 102, the locator 104 sounds an audible recorded message 112. As mentioned, the recorded message 112 may be a pre-recorded message. Thus, the locator 104 may include a memory that stores one or more pre-recorded messages. If more than one prerecorded message is stored in the memory of the locator 104, the recorded message 112 to be played at a given time may be selected randomly or in accordance with a predetermined sequence. In addition, the recorded message 112 played by the locator 104 may be a custom message recorded by the user. Thus, the locator 104 may be configured to record and store customized messages in a memory. In one embodiment, the system may be configured such that the button 108 of the transmitter 102 is pushed and quickly released to generate a control signal 110 that commands the locator 104 to play a recorded message 112 and is pushed and held to generate a control signal 110 that commands the locator 104 to record a message. As an example, the user may speak or otherwise input the message into a microphone integrated into the locator 104, while depressing the button 108 of the transmitter 102.

The transmitter 102 and the locator 104 may each take virtually any size and form. Preferably, the transmitter 102 and locator 104 are small and compact devices that can be easily attached to other objects without hampering the normal functionality or use of those other objects. As an example, the transmitter 102 and locator 104 may each be housed in small plastic devices that can be adhesively attached to objects such as a television 106 and a remote control unit 105. In certain embodiments, the transmitter 102 and/or the locator 104 may take the form of a key chain or may be suitably adapted for attachment to a key chain.

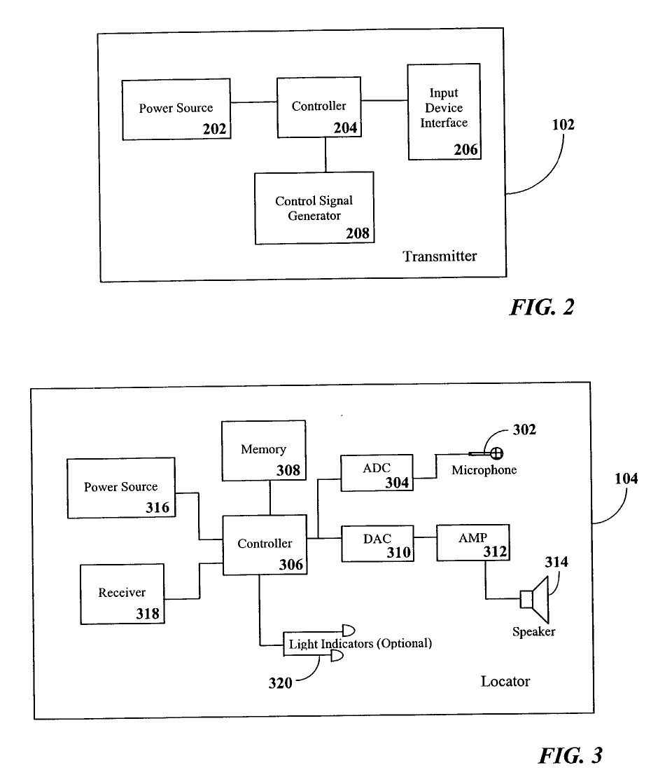

FIG. 2 is a block diagram showing the major components of a transmitter 102 in accordance with exemplary embodiments of the present invention. A power supply 202 powers the transmitter 102 in a conventional manner. The power supply 202 may be a battery, such as a disposable battery or a rechargeable battery. Alternatively, the power supply 202 may be an AC or DC power outlet. In certain embodiments, for example where the present invention is used for the location of a remote control unit 105, the transmitter 102 can be coupled to the same power supply 202 that is used to power the television 106 or other audio/video equipment. Likewise, the transmitter 102 can be coupled to the same power supply 202 that is used to power the circuitry of any other appropriate household appliance.

The power supply 202 may supply power to a controller 204, which may be a microchip or other logic circuitry. The controller 204 may be configured for receiving and interpreting commands from an input device interface 206. The input device interface 206 may accept mechanical and/or electrical signals from a button 108 or other input device. In some embodiments, the input device may be a microphone for detecting audible commands or vibrations or a receiver for receiving wireless analog or digital signals.

The input device interface 206 may therefore pass input commands to the controller 204, converting the input commands into signals recognized by the controller if necessary. As previously mentioned, a certain type of input command maybe interpreted by the controller 204 as a request to locate an object, i.e., play a recorded message 112 stored on the locator 104. Multiple input commands for requesting location of an object are possible. By way of illustration only, a single push of a button 108 may be interpreted as a request to play a first recorded message, two pushes of a button 108 may be interpreted as a request to play a second recorded message, and so on. Another type of input command may be interpreted by the controller 204 as a request to record an audible message for storage in a memory of the locator 104.

The controller 204 interprets the input commands received from the input device interface 206 as appropriate and generates a suitable signal generation command. Signal generation commands are passed to a signal generator 208. In response to receiving a signal generation command, the signal generator 208 generates and transmits the appropriate control signal for reception by the locator 104. The signal generator 208 may be connected to a suitable antenna, if desired, in order to increase the range of the emitted control signal 110.

The control signal 110 emitted by the transmitter 102 may be made to have a range that includes all points within an average house or other area of intended use. The control signal 110 from the transmitter 102 is preferably able to penetrate partition walls and ceilings, so that an object, such as a remote control unit 105, can be located if it has been carried away from its original location. However, it may be desirable to place limits on the control signal range, so as to avoid interference with similar transmitter/locator pairs used within neighboring households or other locations. As will be apparent to those of ordinary skill in the art, control signal range can be determined by the power level of the control signal and/or the configuration of the antenna (if used).

In certain embodiments, transmitter/locator pairs can be designed to operate at varying frequencies, so that a first pair does not transmit and receive control signals 110 using the same frequency as a second pair. In this way, one transmitter 102 will activate only one locator 104, which allows multiple transmitter/locator pairs to be used within a given area without interfering with each other. Varying the frequencies used by transmitter/locator pairs also allows signal strength to be increased without concern for interference among transmitter/locator pairs. Optionally, transmitter/locator pairs may be color-coded or otherwise identified so as to indicate which transmitter 102 is paired with which locator 104. In alternative embodiments, it may be desirable to have one transmitter 102 activate multiple locators 104, to have multiple transmitters 102 activate one locator 104 or to have multiple transmitters 102 activate multiple locators 104.

Although not shown in the figure, the transmitter 102 may also optionally include lamps or other indicators that provide visible and/or audible alerts that inform the user that the transmitter 102 is operational and/or has received an input command. In addition, multiple buttons 108 or other input mechanisms may be provided for generating different input commands. For example, a first button 108 or other input mechanism may be used to input commands for playing recorded messages 112 while a second button 108 or other input mechanism may be used to input commands for recording a message. An on/off button and/or volume control may be included. Other button 108 or input mechanism configurations are also contemplated.

Those skilled in the art will appreciate that the configurations and components of the transmitter 102 shown and described with reference to FIG. 2 are by way of illustration only and that other configurations and components are possible. The described circuitry for the transmitter 102 is intended to be entirely conventional. Other custom-built circuits are also feasible. Accordingly, the invention should not be deemed limited to any particular circuit design for the transmitter 102.

FIG. 3 is a block diagram of the major components of a locator 104 in accordance with exemplary embodiments of the present invention. The locator 104 stores and play recorded messages 110, which may be pre-recorded messages or user-recorded messages. Pre-recorded messages may be stored in the memory 308 by the manufacturer or supplier. Pre-recorded messages may be voice messages, music or other sounds. A microphone 302 is provided for receiving user-supplied voice messages or other sounds. The microphone 302 converts audio information into electrical signals that may be input to an analog-to-digital converter (“ADC”) 304. The digital output of ADC 304 is input to a controller 306 for subsequent processing and storage in memory 308. In alternative embodiments, the ADC 304 may not be included and the audio information may be stored in analog form.

In alternative embodiments, the locator 104 may include a port (not shown), which may be serial or parallel, for interfacing any suitable external device with the controller 306. Audio information received from the port may be sent to the controller 306 for processing and storage in memory 308. By connecting an external device, such as a tape recorder, CD player, digital music player, personal computer, etc. to the locator 104, the user may be able to input his/her own pre-recorded messages into the memory 308 for subsequent playback. The user's own pre-recorded messages may be in digital or analog form.

The controller 306 is programmed to provide overall circuit coordination and control. The controller 306 may also provide compression and expansion or other processing of recorded message 112 using known compression/expansion or other processing techniques. The controller 306 can be any suitable microprocessor, digital processing unit or other logic circuitry. The memory 308 can be dynamic or static random access memory (“RAM”) (with or without separate battery back-up), read only memory (“ROM”), programmable read only memory (“PROM”) (either UV, electrically erasable, non-erasable, or one time programmable), optical disks, memory cards, serial memory (such as bubble memory) or any other suitable medium for storing analog and/or digital information.

The controller 306 controls playback of recorded messages 112 stored in memory 308. Digital information representing a recorded message 112 may be output from memory 308 to a digital to analog converter (“DAC”) 310. The analog output of DAC 310 may be connected to an amplifier 312. The amplified output of the amplifier 312 may be supplied to a speaker 314. The speaker 314 converts the amplified output into audio waves perceptible to a human listener. Depending on the desired sound quality, DAC 310 or amplifier 312 may include conventional filtering circuitry for elimination of circuit noise or the like.

The controller 306 receives control signals from the receiver 318. In certain embodiments, the receiver 318 may be configured for receiving two or more types of control signals 110 from the transmitter 102. For example, a first type of control signal 110 may represent a command to play a recorded message 112. A second type of control signal may represent a command to record an audible message. As mentioned previously, other types of control signals representing alternative and/or additional commands are contemplated by the present invention. The receiver 318 may include an antenna component (not shown) if desired to enhance signal detection. The receiver 318 provides any detected control signals 110 to the controller 306 in an appropriate form. The controller 306 interprets control signals and responds accordingly, for example by initiating playback of a recorded message or recording of a new audible message.

The locator 104 is powered by a power source 316. In preferred embodiments, the power source 316 is a battery. The battery may optionally be a rechargeable battery. In other embodiments, power source 316 is connected to an AC or DC power supply. In certain exemplary embodiments the locator 104 may be configured to share a power supply with the object to which the locator 104 is attached. For example, if the locator 104 is attached to a remote control unit 105, the power source 316 for the locator 104 may be the battery or other power supply that powers the remote control unit 105.

The locator 104 may optionally include light indicators 320, such as lamps or LED, which may be activated by the controller 306 to provide a visible indication of the location of the locator 104. The light indicators 320 may provide continuous light signals or flashing light signals. By way of example, the controller 306 may activate the light indicators 320 in conjunction with initiating playback of a recorded message 112.

Those skilled in the art will appreciate that the configurations and components of the locator 104 shown and described with reference to FIG. 3 are by way of illustration only and that other configurations and components are possible. The described circuitry for the locator 104 is intended to be entirely conventional. Other custom-built circuits are also feasible. Accordingly, the invention should not be deemed limited to any particular circuit design for the locator 104.

In certain embodiments, the circuitry of the locator 104 may be modified such that the playback volume level of the recorded message 112 is made to vary according to the strength of the signal 110 received from the transmitter 102. Thus, the loudness of the recorded message 112 may give an indication of how far the locator 104 is from the transmitter 102. In certain embodiments, the transmitter 102 and/or the locator 104 may include circuitry for detection and indication of low battery conditions.

As may be seen from the foregoing, the present invention provides systems and methods for locating an object using a transmitter and a talking locator device. Those skilled in the art will appreciate that the foregoing description of exemplary embodiments of the invention was provided by way of illustration only and that many other modifications, features, embodiments and operating environments are possible. It should also be appreciated that the exemplary aspects of the present invention as described above are not intended to be interpreted as required or essential elements of the invention, unless explicitly stated as such.

We claim:

1. A talking locator device for locating an object comprising:
recording means for recording at least one audible message;
receiver means for receiving control signals wirelessly transmitted by a remotely located transmitter;
control means responsive to a first type of control signal for initiating playback of at least one of the audible messages and responsive to a second type of control signal for initiating recording of at least one of the audible messages; and
means for attaching the talking locator device to an object to be located.

2. The talking locator device of claim 1, wherein said transmitter includes a control mechanism;
wherein the transmitter is operable to transmit said first type of control signal in response to a user operating the control mechanism in a first manner; and
wherein the transmitter is operable to transmit said second type of control signal in response to the user operating the control mechanism in a second manner.

3. The talking locator device of claim 1, wherein said transmitter includes a first control mechanism and a second control mechanism;
wherein the transmitter is operable to transmit said first type of control signal in response to a user operating the first control mechanism; and
wherein the transmitter is operable to transmit said second type of control signal in response to the user operating the second control mechanism.

4. The talking locator device of claim 1, wherein at least one of the audible messages is made in a user's voice.

5. The talking locator device of claim 1, wherein said first type of control signal is transmitted by the transmitter at a first frequency;
wherein said second type of control signal is transmitted by the transmitter at a second frequency; and
wherein said receiver means for receiving the control signals is tuned to the first frequency and the second frequency.

6. The talking locator device of claim 1, wherein a volume level for playback of the audible messages is proportional to a strength of the first type of control signal received from the transmitter.

7. The talking locator device of claim 1, wherein control means are responsive to said first type of control signal for initiating playback of at least one randomly selected recorded audible messages.

8. The talking locator device of claim 1, further comprising means for receiving and storing at least one audio file from an external device; and
wherein said control means are responsive to said first type of control signal for initiating playback of at least one of the stored audio files.

9. A talking locator device for locating an object comprising:
a microphone for receiving sound and converting the sound into electrical signals;
a memory for storing the electrical signals as at least one recorded message;
a receiver for receiving control signals wirelessly transmitted by a remotely located transmitter;
a controller responsive to a first type of control signal for initiating playback of at least one of the recorded messages via a speaker and responsive to a second type of control signal for activating the microphone to receive the sound in order to record the recorded message; and
means for attaching the talking locator device to an object to be located.

10. The talking locator device of claim 9, wherein the transmitter includes a control mechanism;
wherein the transmitter is operable to transmit the first type of control signal in response to a user operating the control mechanism in a first manner; and
wherein the transmitter is operable to transmit the second type of control signal in response to a user operating the control mechanism in a second manner.

11. The talking locator device of claim 9, wherein the transmitter includes a first control mechanism and a second control mechanism;
wherein the transmitter is operable to transmit the first type of control signal in response to a user operating the first control mechanism; and
wherein the transmitter is operable to transmit the second type of control signal in response to the user operating the second control mechanism.

12. The talking locator device of claim 9, wherein the sound comprises a user's voice.

13. The talking locator device of claim 9, wherein said first type of control signal is transmitted by the transmitter at a first frequency;
wherein said second type of control signal is transmitted by the transmitter at a second frequency; and
wherein said receiver is tuned to the first frequency and the second frequency.

14. The talking locator device of claim 9, wherein a volume level for playback of the recorded messages is proportional to a strength of the first type of control signal received from the transmitter.

15. The talking locator device of claim 9, wherein said controller is responsive to said first type of control signal for initiating playback of at least one randomly selected recorded message.

16. The talking locator device of claim 9, further comprising a port for receiving and storing at least one audio file from an external device; and
wherein said controller is responsive to said first type of control signal for initiating playback of at least one of the stored audio files.

17. A system for locating an object comprising:
a locator attached to an object to be located, the locator comprising means for storing at least one recorded voice message and playback means for playing at least one of the recorded voice messages in response to a control signal being received by the locator; and
a transmitter located remote from the locator for wirelessly transmitting the control signal in response to activation by a user.

18. The system of claim 17, wherein at least one of the recorded voice messages comprises a pre-recorded message.

19. The system of claim 17, wherein the locator further comprises recording means for recording at least one of the recorded voice messages.

20. The system of claim 19, wherein the recording means are responsive to a second control signal being received by the locator; and
wherein the transmitter is operable to transmit the second control signal upon activation by the user.

21. The system of claim 19, wherein at least one of the recorded voice message comprises a recording of the user's voice.

22. The system of claim 19, wherein the transmitter and the locator are similarly colored so as to indicate a correspondence between the transmitter and the locator.

23. The system of claim 19, wherein said control signal is transmitted by the transmitter at a first frequency;
wherein said second control signal is transmitted by the transmitter at a second frequency; and
wherein said locator comprises a receiver tuned to the first frequency and the second frequency.

24. The system of claim 17, wherein a volume level for playback of the recorded voice messages is proportional to a strength of the control signal received from the transmitter.

25. The system of claim 17, wherein said playback means are adapted for playing at least one randomly selected recorded voice message.

26. The system of claim 17, further comprising a port for receiving and storing at least one audio file from an external device; and
wherein said playback means are adapted for playing of at least one of the stored audio files responsive to said control signal being received by the locator.
